(19) United States
(12) Patent Application Publication
(10) Pub. No.: US 2007/0020077 A1
(43) Pub. Date: Jan. 25, 2007

(54) VEHICLE LIFTING ADAPTER

(75) Inventors: Chad Lee BURCHETT, Kernersville, NC (US); James David TILLEY, Greensboro, NC (US); Karl Thomas SCHWAGERL, Christiansburg, VA (US)

Correspondence Address: NOVAK DRUCE & QUIGG, LLP, 1300 EYE STREET NW, 400 EAST TOWER, WASHINGTON, DC, 20005, US

(73) Assignee: VOLVO TRUCKS NORTH AMERICA, Greensboro, NC (US)

(21) Appl. No.: 11/161,112

(22) Filed: Jul. 22, 2005

(51) Int. Cl. B60P 1/48

(52) U.S. Cl. 414/563

(57) ABSTRACT

Method and arrangement for raising at least one wheel of a vehicle off of, or above the ground. The arrangement includes an adapter body configured to be secured to a hub of a vehicle at a position external to a wheel mounted on the hub and that is to be raised above ground. The adapter body includes a hub connection portion that is configured to be secured on threaded lug extensions protruding beyond wheel-securing lug nuts of the wheel. The adapter body also includes a connection receiving portion that is configured for interconnection with a lift that imposes a lifting force on the adapter body sufficient to raise the wheel above ground. The hub connection portion of the adapter includes a connection plate that defines a first plane. The connection receiving portion includes a lifting plate substantially defining a second plane through which an opening is provided. The lifting plate is interconnected with the connection plate by an offset portion configured so that the lifting plate is substantially parallel to, but offset from the connection plate. The connection plate has a pattern of holes formed therein and which are configured for alignment with a plurality of threaded lug extensions protruding beyond wheel-securing lug nuts on the wheel.

### TECHNICAL FIELD

The present invention relates generally to lifting devices for heavy vehicles, including providing an economical method for transporting trucks using a nested or decked configuration. More particularly, the present invention relates to an assist for lifting the front wheels of a truck off the ground sufficiently high to permit easy decking and undecking operations.

### BACKGROUND OF THE INVENTION

The transportation of goods and equipment using heavy duty, long distance trucks has become a well developed industry. Efficient and profitable operation of delivery trucks dictates that each truck in a fleet travel as much as possible with a payload, and not empty. On long trips it is desirable for a truck to carry one payload on the outbound trip and another payload on the return trip. Frequently there is no payload for the return trip, which is uneconomical due to fuel consumption and wear and tear on the vehicle.

One way to overcome the difficulties surrounding full utilization of trucks involves organizing fleet activity so that two or more trucks empty their loads near the same location at nearly the same times so that their return trips can coincide. In the absence of return payloads, the cost of return of at least one of the trucks can be substantially avoided if transported back to the originating location either loaded on or towed by the other truck.

Loading one truck on another truck or towing one or more trucks by another truck is known from U.S. Pat. No. 4,074,822, U.S. Pat. No. 4,867,468 and U.S. Pat. No. 5,873,593 for the purpose of truck return or for sending truck cabin, drivetrain and/or frame assemblies from their manufacturers to a truck body company that completes the vehicle structure, ready for use. In these regards, when trucks are themselves being shipped, a common method of transport which requires only one of the trucks to be operational during travel uses a lead truck that tows the remaining trucks in piggyback configuration. The organization of several trucks in this fashion is also referred to as “decking” the trucks.

The piggyback or decked method of truck towing requires that the frontal structure of the towed truck(s) be raised for coupling to a rear structure of the towing vehicle or a preceding truck in a series of trucks. Similarly, such systems can employ a fifth wheel hitch, gooseneck or other type of receiver on the towing or preceding vehicle to be coupled to the front “dead” or beam-type axle of the following vehicle. Coupling of the following truck to one in front can be accomplished using a depending pin assembly mounted to the front axle to be received in the aperture of the fifth wheel hitch or similar receiver on the towing or preceding vehicle. An early piggyback method for towing a plurality of trucks required removal of the front wheels of all the towed or decked trucks.

The method disclosed in U.S. Pat. No. 4,867,468 does not require the removal of the towed trucks' front wheels. In this case, a decking bar is used that engages a saddle arrangement mounted to the towing truck's chassis, rearward of the fifth wheel hitch. By using the decking bar located forward of the front axle of the towed vehicle, the front wheels can be kept on that vehicle without interfering with the drive wheels of the towing or preceding vehicle. Further versatility for decking of trucks, piggyback style, is disclosed in U.S. Pat. No. 5,873,593.

Regardless of the previously known methods for decking trucks for transportation in a piggyback arrangement, it still remains that the front end of each truck to be decked must be raised in order to be properly mounted on the preceding vehicle. To facilitate raising these trucks' front ends, a pair of rings or eyelets are typically provided that protrude from the vehicle's front bumper. Such rings or eyelets are configured for receiving hooks attached to a lifting device that lifts the front of the truck for decking behind a preceding truck. During the raising of a truck, it is not uncommon for extension members (chains, cables, straps or the like) that provide the connection between the lifting device and the bumper rings to contact the aerodynamic farings, bumpers and/or fenders of the truck causing visible damage to these usually polished surfaces.

From this it becomes obvious that an alternative method of lifting the front end of trucks during decking and undecking is desirable that gives consideration to the design and positioning of the equipment used to raise the front of the truck off the ground and into position for such transportation. The desired improvement is important for trucks that include an exposed front recovery system that could be particularly susceptible to damage.

In view of the above described deficiencies associated with the use of known lifting arrangements for attachment in the proximity of a truck's front bumper, the present invention has been developed to alleviate current drawbacks and provide further benefits to the user. These enhancements and benefits are presented in greater detail hereinbelow by way of exemplary embodiments of the present invention.

### SUMMARY OF THE INVENTION

The present invention alleviates the drawbacks described above with reference to currently available equipment and processes for raising and decking vehicles for transportation. A process according to the present invention uses a lifting adapter connected at the front wheel of the vehicle, rather than to the vehicle's bumper. The lifting adapter is a two part structure having a connection plate at one end, for attachment to a wheel (front) of a truck and a lifting plate designed to receive a hook or similar tool extending from a lifting device that is sufficiently powerful to raise the front of the truck into the decking position. A vehicle lifting adapter according to the present invention may be fabricated from any suitable structural material such as iron, steel or other high-strength construction material.

The process for raising a truck includes positioning holes in the connection plate of the lifting adapter adjacent to the lug nuts located outside the wheel of the truck. This occurs without disturbing factory torque used to secure the wheel to the wheel hub since there is commonly an excess extension of the threaded wheel lugs outside the wheel, and even beyond the nuts holding the wheel on the hub. It is this excess portion beyond the lug nuts which is referred to herein as wheel stud extensions, or threaded lug extensions, which are used for securing the present lifting adapter at the respective truck wheel. The lifting adapter of the present invention distributes the weight of the truck being lifting so that it is substantially evenly distributed to all the engaged wheel studs (it should be appreciated that it is not necessary that all wheel stud extensions at the particular wheel be engaged) because when properly installed, a substantial conformance fit exists between the adapter and the wheel studs. Still further, the depth or height of the wheel nuts (the dimension measured along the longitudinal axis of the nut) provide a buffer between the adapter and the wheel itself; when properly installed, contact between the adapter and wheel is prevented.

The nuts that are used to secure the lifting adapter to the stud extensions are preferably designed to include a hand-grip portion that accommodates an installer's direct grasp of the nut for proper tightening. In this preferred embodiment, the lifting adapter can easily be installed on a truck wheel without resort to special tools or the like when securing the adapter at the truck wheel.

The raising of the front portion of a truck employs a process in which a lifting adapter, configured according to the present invention's teaching, is secured by a connection plate portion of the adapter to each of the front wheels of the vehicle. When correctly positioned, a lifting plate portion of the lifting adapter extends upwards from the connection plate of the particular adapter.

An offset of the lifting plate from the connection plate orients the lifting plate of each lifting adapter on a plane that is located outside the outer edge of the fender of the truck body. Spacing of the lifting plate beyond the fender reduces the probability of damage-causing contact between the fender and the hook or connection tool used to attach a lifting adapter to a lifting device. By employing this configuration the raising of the front end of a truck using two lifting devices, such as hoists or cranes, is facilitated. Alternatively, and preferably, a single lifting device can be utilized and from which two extension connectors (belts, straps or the like) are suspended with a spreader bar or similar arrangement positioned therebetween for maintaining proper spacing between the extension connectors. Compared to the vehicle to be lifted, the spreader bar should have a length sufficient to maintain spacing between the extension connectors wide enough to keep those connectors well clear of the truck's cab structure, including the hood, fenders and front bumper during the lifting process.

The lifting adapter and process according to the present invention provide an effective approach for decking and undecking vehicles. It is anticipated that the simplicity and ease-of-use of the present invention will make this approach readily compatible with current processes used for decking trucks for transportation. Equipment such as spreader bars and lifting adapters represent relatively inexpensive items that can be maintained at the several sites where decking and undecking is to occur.

In at least one embodiment, the invention takes the form of an arrangement for raising at least one wheel of a vehicle off of, or above the ground. The arrangement comprises an adapter body configured to be secured to a hub of a vehicle at a position external to a wheel mounted on the hub and that is to be raised above ground. The adapter body includes a hub connection portion that is configured to be secured on threaded lug extensions protruding beyond wheel-securing lug nuts of the wheel. The adapter body also includes a connection receiving portion that is configured for interconnection with a lift that imposes a lifting force on the adapter body sufficient to raise the wheel above ground.

In one development or version of this embodiment, the hub connection portion comprises a connection plate that defines a first plane. By this terminology, it should be understood that the defined plane constitutes a substantially centered plane within the connection plate. In a similar manner, the connection receiving portion comprises a lifting plate substantially defining a second plane and having an opening therethrough. The lifting plate is interconnected with the connection plate by an offset portion configured so that the lifting plate is substantially parallel to, but offset from the connection plate. The connection plate has a pattern of holes formed therein and configured for alignment with a plurality of threaded lug extensions protruding beyond wheel-securing lug nuts on the wheel.

In still a further development, the offset portion defines a third plane transversely oriented with respect to the first and second planes. In this manner, the offset portion defines a spacing distance between the parallel lifting and connection plates.

In yet a further development, brace webbing is incorporated that interconnects the lifting plate, the connection plate and the offset portion. The brace webbing strengthens the adapter, and fortifies it against deformation.

In one aspect, the opening through the lifting plate is an aperture configured to insertibly receive a lift-hook. In another, the lifting plate is integrally formed with the connection plate.

In a related embodiment, the invention takes the form of an arrangement for raising a pair of wheels of a vehicle above ground. The arrangement comprises a pair of adapters, each suspended on a lifting strap that is interconnected to a lift device. A space-maintaining spreader is interposed between the straps for keeping them sufficiently apart from one another that abutment with the vehicle during the lifting process is avoided. In this embodiment, each of the adapters is configured as described in the several paragraphs immediately above.

In a related aspect, the invention takes the form of a method for raising a pair of hub-mounted wheels of a vehicle above ground. The method includes installing a pair of adapters, one at each of the two wheels of the pair. Each of the adapters is suspended on a lifting strap that is interconnected to a lift device. A space-maintaining spreader is interposed between the straps in order to avoid contact with the vehicle itself during the lifting process. Each of the adapters is secured adjacent to, and externally of a respective wheel by first mating receiving holes in the adapter over threaded lug extensions protruding beyond the respective wheel and lug nuts, and then installing and tightening a set of securing nuts onto the threaded lug extensions.

In a subsequent step, a lifting force is imposed on each of the pair of adapters using the lift device and in this manner drawing each of the two wheels above the ground until a spacing distance is established between the two wheels and the ground. In a preferred embodiment, that spacing distance is sufficient to mount the lifted truck onto a towing truck in a decked configuration. Still further, in this embodiment of the invention that is directed toward the lifting method, the employed adapters are configured according to the description above.

The beneficial effects described above apply generally to the exemplary devices and mechanisms disclosed herein regarding the method and arrangement for raising a portion of a vehicle, particularly for decking/undecking purposes. The specific structures through which these benefits are delivered will be described in detail hereinbelow.

### BRIEF DESCRIPTION OF THE DRAWINGS

The invention will now be described in greater detail in the following way of example only and with reference to the attached drawings, in which:

FIG. 1 is a front perspective view of a truck cab showing a prior art lifting assembly;

FIG. 2 is a perspective view of the front of a truck showing an alternative prior art lifting arrangement that utilizes protective padding for the truck bumper;

FIG. 3 is a perspective view of a vehicle lifting adapter configured according to the teachings of the present invention;

FIG. 4 is a side plan view of the vehicle lifting adapter shown in FIG. 3;

FIG. 5 is an edge view of the vehicle lifting adapter shown in FIG. 3;

FIG. 6 is a side plan view of the vehicle lifting adapter shown in FIG. 3 installed upon a wheel of a vehicle;

FIG. 7 is a side elevational view, taken from a front perspective, of the installed configuration of the adapter as shown in FIG. 6;

FIG. 8 is a perspective view of an alternative embodiment of an adapter that includes brace webbing or flanges;

FIG. 9 is a diagramatic view of the front portion of a truck with a vehicle lifting adapter secured to a front wheel of the truck and connected to an overhead lifting device; and

FIG. 10 is a diagramatic view of the front of a truck cab showing a spreader bar above the truck's hood that is used to maintain space between the suspension straps of the lifting device.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale and some features may be exaggerated or minimized to show details of particular components and features. Therefore, specific structural and functional details disclosed herein are not to be interpreted as limiting, but are provided on a representative basis for teaching one skilled in the art how to variously employ the present invention.

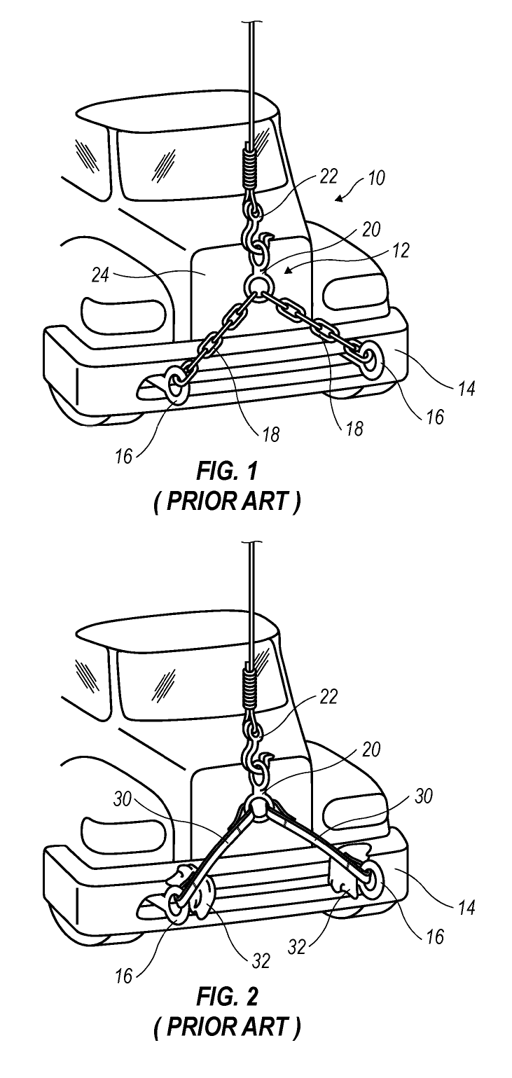

Referring to the figures, wherein like numbers refer to like parts throughout the several views, FIG. 1 provides a front view of a traditional truck cab 10 showing a prior art lifting assembly 12 involving mainly the bumper 14 of the truck. A pair of rings or eyelets 16 that project from the chassis of the truck (not shown) through the bumper 14 provide convenient points for attaching a lifting chain 18 joined between the rings 16. At the approximate center of the lifting chain 18, a connecting link 20 provides a point for attaching a hook 22 suspended from a lifting arrangement that operates to lift the truck cab 10 during nesting or decking of trucks for transportation.

The prior art lifting assembly 12 is effective for lifting the front portion of trucks, but the close proximity of the assembly 12 to the bumper 14 and radiator/grill 24 of the truck cab 10 increases the risk of damage to these vehicle parts, or at least polished surfaces thereof.

FIG. 2 illustrates the use of yet another previously known lift arrangement in which a fabric strap 30 is attached to the bumper 14 of a truck cab 10. The strap 30 may be less rigid and abrasive than the lifting chain 18 of the arrangement shown in FIG. 1, but nevertheless, when under the tension that the weight of the vehicle imposes, the belt 30 becomes rigid enough to apply significant force during lifting of a truck cab 10 to cause distortion of truck panels that inadvertently become weight bearing surfaces in the process of decking one truck on another. For this reason, a protective pad 32 may be placed behind the strap 30 to cushion the bumper 14 from damage by the strap 30 during lifting of the truck for decking.

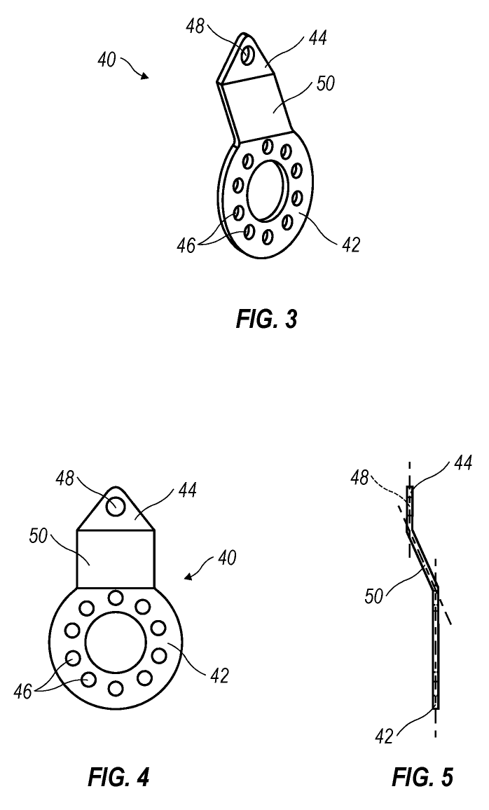

FIGS. 3-5 provide illustration of a vehicle lifting adapter 40 configured according to the teachings of the present invention. The adapter 40 is composed of a body that comprises a connection plate 42 and a lifting plate 44. The connection plate 42 includes a plurality of holes 46 having a hole-pattern matching that of the wheel lugs or studs 65 used to secure a wheel 54 to a hub 64 of a vehicle 100 that is to have one or more tires lifted off-ground as depicted in FIG. 7.

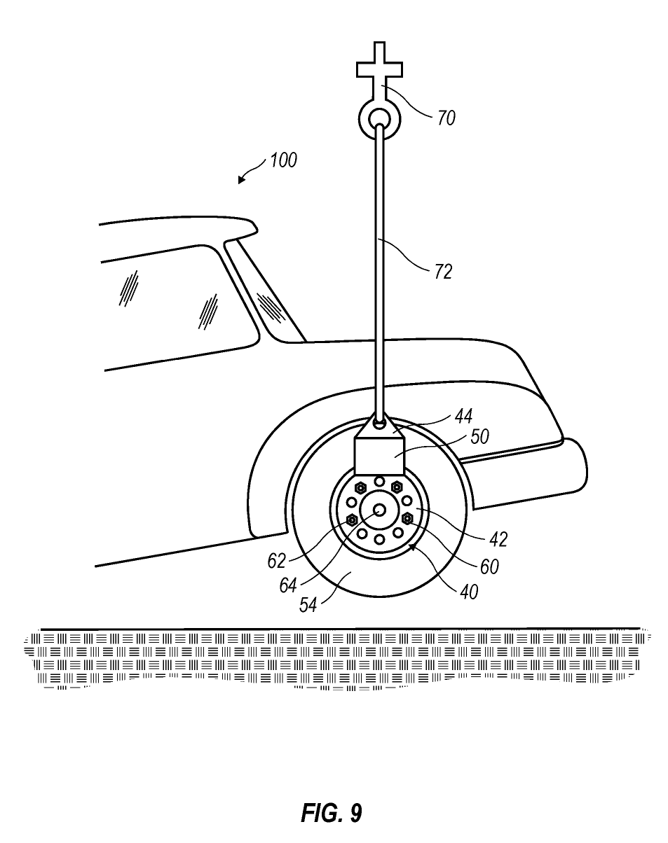

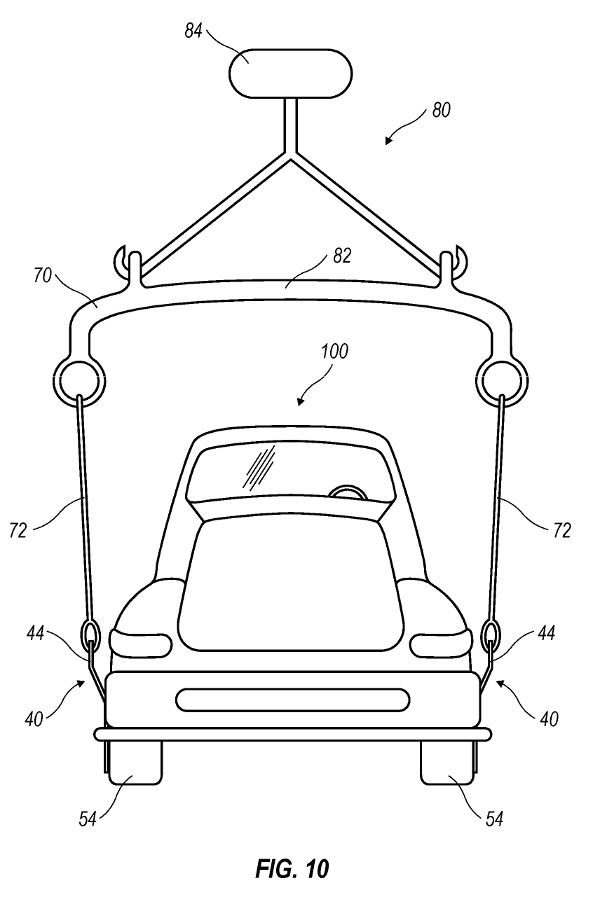

The lifting plate 44 extends from the connection plate 42 and has an opening 48 therein which provides a convenient means for attachment of a lifting connector, such as a J-hook, during use of the adapter 40 as a component in a vehicle raising assembly 80 as depicted in FIGS. 9 and 10. Although the figures show the patterned holes 46 and opening 48 to have a circular shape, other shapes are also suitable. An offset portion 50 of the adapter body 40 between the lifting plate 44 and connection plate 42 spaces the two parallel plates apart and is intended to prevent contact between any portion of the truck's 100 cab 10 and the vehicle raising assembly 80. In this manner, damage to the involved vehicle during decking and undecking will be substantially eliminated.

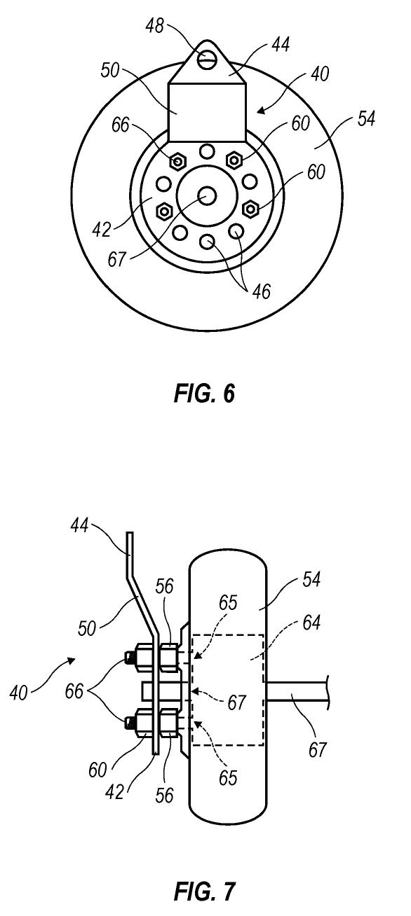

FIG. 6 shows a lifting adapter 40 configured according to the present invention and secured adjacent to the vehicle wheel 54 using a suitable retainer 60 such as one or more oversized lug nuts, exemplarily designed to include a grip portion so that the lifting adapter 40 can be installed next to a truck wheel 54 without depending on conventional or special tools to assemble the connection plate 42 of the lifting adapter 40 at the wheel 54 of the truck 100. In conventional wheel and hub designs, the wheel lugs 65 are long enough to provide a threaded extension 66 beyond the outer end of lug nuts 56 that secure the wheel 54 to the wheel hub 64 of the truck 100. The pattern of holes 46 in the connection plate 42 of a vehicle lifting adapter 40 is configured to correspond to the pattern of the wheel stud extensions 66 which are received therein.

In one embodiment, each of the plurality of stud patterned holes 46 has a diameter slightly larger than the outside diameter of a corresponding wheel-securing lug nut 56. In this configuration, however, a washer is installed over each stud extension outside of the respective lug nut 56, but inside of the connection plate 42. The washer is selected to have an internal diameter slightly greater than the threaded lug extension 66, but slightly smaller than the outside diameter of the lug nut 56. On the other hand, the outside diameter of the washer is sized to be greater than the corresponding hole 46 in the connection plate 42. In this configuration, the connection plate 42 seats against the washer outside each lug nut without making contact with the surface of the wheel 54. Separation of the connection plate 42 from the surface of the wheel 54 reduces the likelihood of damage to the wheel 54 that could otherwise be caused by contact with a lifting adapter 40 during the lifting process.

FIG. 7, by way of an edge view of the vehicle lifting adapter 40, more clearly shows the adapter 40 positioned over wheel stud extensions 66 that each have an extending portion of sufficient length to attach a second lug nut 60 or other suitable retainer for securing the lifting adapter 40 to the hub 64 at the wheel 54. The wheel hub 64 is depicted schematically, and in dashed-line showing an exemplary relationship to the wheel/tire 54, axle 67 and lifting adapter 40 in an installed configuration.

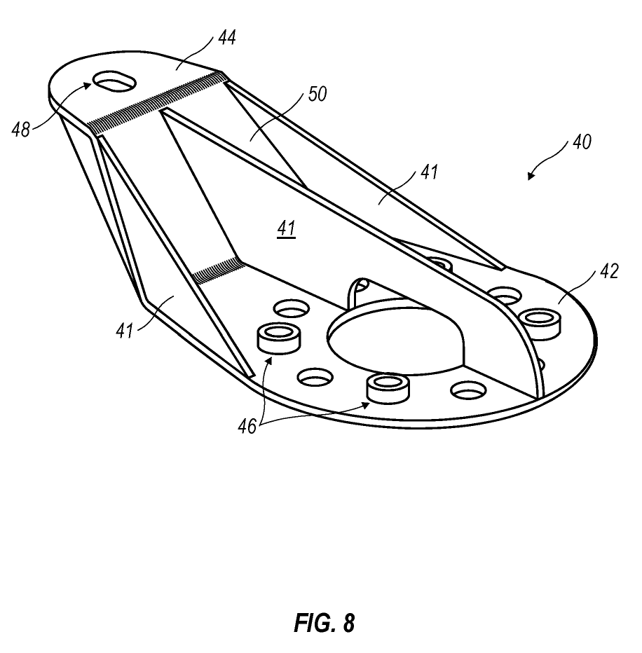

FIG. 8 illustrates an alternative embodiment of the lift adapter 40 substantially similar to that shown in FIGS. 3-5, but in this variation, brace webbing 41 has been added between the connection plate 42 and offset portion 50 to fortify the adapter body 40.

FIG. 9 is a side view showing a truck cab 100 and a lifting device 70 connected to a vehicle adapter plate 40 via a lifting strap 72 according to the teachings of the present invention.

FIG. 10 illustrates the use of a spreader bar 82 that in the embodiment shown acts to distribute the weight of a truck cab 10 between a pair of vehicle lifting adapters 40 attached to each of the front wheels 54 of the vehicle. The spreader bar 82 facilitates use of a single lifting device 84 for raising the front end of a vehicle during nesting or decking of vehicles. Alternatively, the spreader bar 82 may be merely interposed lengthwise between the straps 72 to maintain a sufficient distance therebetween so that the truck 100 is not contacted by the lifting assembly 80 during the lifting process.

A vehicle lifting adapter and its components have been described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

What is claimed is:

1. An arrangement for raising at least one wheel of a vehicle above ground, said arrangement comprising:
an adapter body configured to be secured to a hub of a vehicle at a position external to a wheel mounted on the hub and which wheel is to be raised above ground;
said adapter body comprising a hub connection portion configured to be secured on threaded lug extensions protruding beyond wheel-securing lug nuts on the wheel to be raised above ground; and
said adapter body further comprising a connection receiving portion configured for interconnection with a lift that imposes a lifting force on said adapter body sufficient to raise the wheel above ground.

2. The arrangement as recited in claim 1, further comprising:
said hub connection portion comprising a connection plate defining a first plane;
said connection receiving portion comprising a lifting plate substantially defining a second plane and having an opening therethrough, said lifting plate being interconnected with said connection plate by an offset portion configured so that said lifting plate is substantially parallel to, but offset from said connection plate; and
said connection plate having a pattern of holes formed therein and configured for alignment with a plurality of threaded lug extensions protruding beyond wheel-securing lug nuts on the wheel to be raised above ground.

3. The arrangement as recited in claim 2, further comprising:
said offset portion defining a third plane obliquely oriented with respect to said first and second planes.

4. The arrangement as recited in claim 3, wherein said offset portion defines a spacing distance between said parallel lifting plate and said connection plate.

5. The arrangement as recited in claim 4, further comprising:
brace webbing, interconnected between said connection plate and said offset portion, said brace webbing fortifying said adapter body against deformation.

6. The arrangement as recited in claim 3, wherein said opening through said lifting plate is an aperture configured to insertibly receive a lift-hook.

7. The arrangement as recited in claim 2, wherein said lifting plate is integral formed with said connection plate.

8. An arrangement for raising a pair of wheels of a vehicle above ground, said arrangement comprising:
a pair of adapters, each suspended on a lifting strap that is interconnected to a lift device with a space-maintaining spreader interposed between said straps; and
each of said adapters comprising:
an adapter body configured to be secured to a hub of a vehicle at a position external to a wheel mounted on the hub and which wheel is to be raised above ground;
said adapter body comprising a hub connection portion configured to be secured on threaded lug extensions protruding beyond wheel-securing lug nuts on the wheel to be raised above ground; and
said adapter body further comprising a connection receiving portion configured for interconnection with a lift that imposes a lifting force on said adapter body sufficient to raise the wheel above ground.

9. The arrangement as recited in claim 8, wherein each of said adapters further comprises:
said hub connection portion comprising a connection plate defining a first plane;
said connection receiving portion comprising a lifting plate defining a second plane and having an opening therethrough, said lifting plate being interconnected with said connection plate by an offset portion configured so that said lifting plate is substantially parallel to, but offset from said connection plate; and
said connection plate having a pattern of holes formed therein and configured for alignment with a plurality of threaded lug extensions protruding beyond wheel-securing lug nuts on the wheel to be raised above ground.

10. The arrangement as recited in claim 9, wherein each of said adapters further comprises:
said offset portion defining a third plane obliquely oriented with respect to said first and second planes.

11. The arrangement as recited in claim 10, wherein the respective offset portion in each of said adapters defines a spacing distance between said respective parallel lifting plate and said connection plate of that adapter.

12. The arrangement as recited in claim 11, wherein each of said adapters further comprises:
brace webbing, interconnected between the respective connection plate and offset portion, said brace webbing fortifying said adapter body against deformation.

13. The arrangement as recited in claim 9, wherein said opening through a lifting plate is an aperture configured to insertibly receive a lift-hook.

14. The arrangement as recited in claim 9, wherein regarding each of said adapters, the respective lifting plate is integrally formed with the respective connection plate.

15. A method for raising a pair of wheels of a vehicle above ground, said method comprising:
installing a pair of adapters, one each onto two wheels of a vehicle that are to be lifted above ground and each of said adapters being suspended on a lifting strap that is interconnected to a lift device and having a space-maintaining spreader interposed between said straps; and
interconnecting each of said adapters at a position external to a respective one of said two wheels, each of which said two wheels is mounted on a hub of the vehicle; and
securing each of said adapters by installing nuts onto threaded lug extensions protruding beyond the respective wheel and through receiving holes in the respective adapter.

16. The method as recited in claim 15, said method further comprising:
imposing a lifting force on each of said pair of adapters using said lift device and thereby drawing each of said two wheels above ground until a spacing distance is established between said two wheels and the ground.

17. The method as recited in claim 16, wherein each of said adapters comprises:
a connection plate defining a first plane and a lifting plate defining a second plane and having an opening therethrough, said lifting plate being interconnected with said connection plate by an offset portion configured so that said lifting plate is substantially parallel to, but offset from said connection plate; and
said connection plate having a pattern of holes formed therein and configured for alignment with a plurality of threaded lug extensions protruding beyond wheel-securing lug nuts on the respective wheel to be raised above ground.

18. The method as recited in claim 17, wherein each of said adapters further comprises:
said respective offset portion defining a third plane transversely oriented with respect to said first and second planes of that adapter.

19. The method as recited in claim 18, wherein the respective offset portion in each of said adapters defines a spacing distance between the respective parallel lifting plate and connection plate of that adapter.

20. The method as recited in claim 18, wherein each of said adapters further comprises:
brace webbing, interconnected between the respective connection plate and offset portion, said brace webbing fortifying said adapter body against deformation.
